(19) United States
(12) Patent Application Publication
(10) Pub. No.: US 2020/0187484 A1
(43) Pub. Date: Jun. 18, 2020

(54) Trap Bait Bag

(71) Applicant: Michael Blattenberger, Bellwood, PA (US)

(72) Inventor: Michael Blattenberger, Bellwood, PA (US)

(21) Appl. No.: 16/218,567

(22) Filed: Dec. 13, 2018

(51) Int. Cl. A01M 23/24

(52) U.S. Cl. CPC A01M 23/245

(57) ABSTRACT

A trap bait bag for increasing rodent trap efficiency includes a food pouch having a shell and an inside. A bait food is disposed within the inside of the food pouch. A strap is coupled to the food pouch. The strap is configured to secure the food pouch to a catch of a spring trap.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to trap baits and more particularly pertains to a new trap bait for increasing rodent trap efficiency.

### BRIEF SUMMARY OF THE INVENTION

An embodiment of the disclosure meets the needs presented above by generally comprising a food pouch having a shell and an inside. A bait food is disposed within the inside of the food pouch. A strap is coupled to the food pouch. The strap is configured to secure the food pouch to a catch of a spring trap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a trap bait bag according to an embodiment of the disclosure.

FIG. 2 is a cross-sectional view of an embodiment of the disclosure along line 2-2 of FIG. 1.

FIG. 3 is an in-use side elevation view of an embodiment of the disclosure.

FIG. 4 is an in-use isometric view of an embodiment of the disclosure.

### DETAILED DESCRIPTION OF THE INVENTION

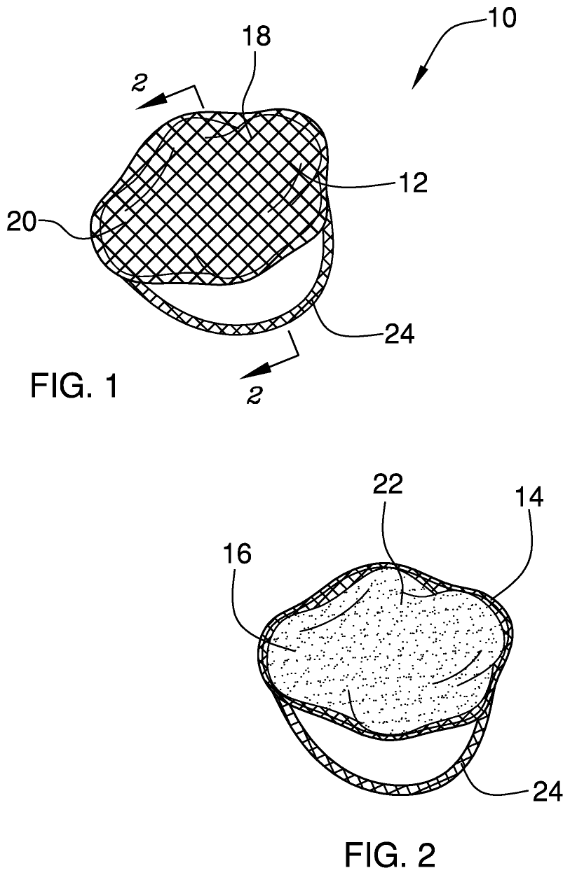

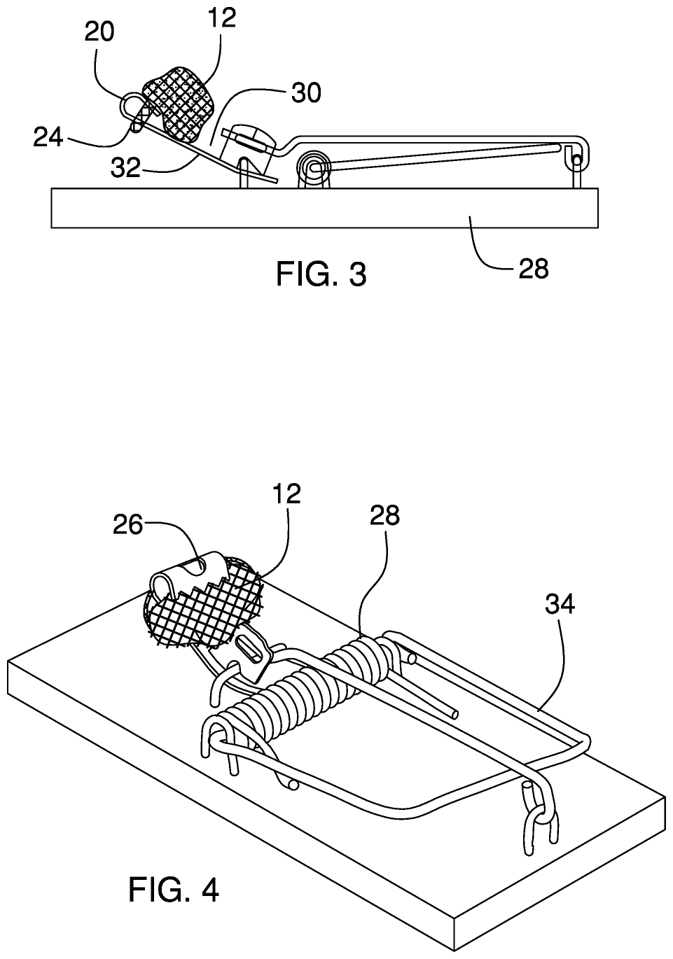

With reference now to the drawings, and in particular to FIGS. 1 through 4 thereof, a new trap bait embodying the principles and concepts of an embodiment of the disclosure and generally designated by the reference numeral 10 will be described.

As best illustrated in FIGS. 1 through 4, the trap bait bag 10 generally comprises a food pouch 12 having a shell 14 and an inside 16. The shell 12 may be a durable mesh material 18 such as a nylon mesh 20. A bait food 22 is coupled to the food pouch 12. The bait food is disposed within the inside 16 of the food pouch and is smellable and lickable through the shell 14 of the food pouch. The bait food 22 may be either cheese or peanut butter. The mesh material 18 is configured to snag a pest's teeth as it attempts to chew through the shell 14 to reach the bait food 22. A strap 24 is coupled to the food pouch 12. The strap 24 is configured to engage with a catch 26 of a spring trap 28.

In use, the food pouch is disposed on a top side 30 of the catch and the strap 24 is extended around a bottom side 32 of the catch. The spring trap 28 is then armed. Once a pest has its teeth snagged in the mesh material 18 after trying to chew through to the bait food 22, it will activate the catch 26 to release a hammer 34 of the spring trap and the pest will be killed or trapped.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A trap bait bag comprising:
a food pouch, the food pouch having a shell and an inside;
a bait food coupled to the food pouch, the bait food being disposed within the inside of the food pouch; and
a strap coupled to the food pouch, the strap being configured to secure the food pouch to a catch of a spring trap.

2. The trap bait bag of claim 1 further comprising the shell of the food pouch being a durable mesh material, the mesh material being configured to expose the bait food to be smelled and licked by a pest and to catch the pest's teeth.

3. The trap bait bag of claim 2 further comprising the durable mesh material being a nylon mesh.

4. The trap bait bag of claim 1 further comprising the bait food being either cheese or peanut butter.

5. The trap bait bag of claim 1, further comprising:
the shell being a durable mesh material, the mesh material being configured to snag a pest's teeth; and
the bait food being smellable and lickable through the shell of the food pouch.

6. The trap bait bag of claim 1, further comprising:
said shell being a nylon mesh;
the bait food being a food chosen from a group of foods consisting of cheese and peanut butter.

7. A spring trap and trap bait bag combination, the combination comprising:
a spring trap, the spring trap comprising a catch having a top side and a bottom side;
a food pouch, the food pouch having a shell and an inside, the shell being a durable mesh material, the mesh material being configured to snag a pest's teeth;
a bait food coupled to the food pouch, the bait food being disposed within the inside of the food pouch, the bait food being smellable and lickable through the shell of the food pouch; and
a strap coupled to the food pouch, the strap being selectively engageable with the catch of the spring trap, the food pouch being disposed on the top side of the catch and the strap extending around the bottom side of the catch.

8. A spring trap and trap bait bag combination, the combination comprising:
a spring trap, the spring trap comprising a catch having a top side and a bottom side;
a food pouch, the food pouch having a shell and an inside, the shell being a nylon mesh, the nylon mesh being configured to snag a pest's teeth;
a bait food coupled to the food pouch, the bait food being disposed within the inside of the food pouch, the bait food being smellable and lickable through the shell of the food pouch, the bait food being either cheese or peanut butter; and
a strap coupled to the food pouch, the strap being selectively engageable with the catch of the spring trap, the food pouch being disposed on the top side of the catch and the strap extending around the bottom side of the catch.
